(19) United States
(12) Patent Application Publication
(10) Pub. No.: US 2026/0304450 A1
(43) Pub. Date: Oct. 1, 2026

(54) METHODS AND APPARATUSES FOR SL TRANSMISSION AND S-SSB TRANSMISSION IN UNLICENSED SPECTRA

(71) Applicant: LENOVO (BEIJING) LIMITED, Beijing (CN)

(72) Inventors: Xin Guo, Beijing (CN); Haipeng Lei, Beijing (CN); Xiaodong Yu, Beijing (CN); Zhennian Sun, Beijing (CN)

(21) Appl. No.: 19/100,157

(22) PCT Filed: Aug. 3, 2022
(86) PCT No.: PCT/CN2022/110112

§ 371 Date: Jan. 31, 2025

(51) Int. Cl. H04W 72/25; H04W 74/08

(52) U.S. Cl. CPC H04W 72/25; H04W 74/0866

(57) ABSTRACT

Embodiments of the present disclosure relate to methods and apparatuses for sidelink (SL) transmission and sidelink synchronization signal block (S-SSB) transmission in unlicensed spectra. According to an embodiment of the present disclosure, a user equipment (UE) can include: a processor configured to: obtain slot structure information for an unlicensed spectrum based on configuration or pre-configuration, wherein the slot structure information includes at least one of the following: a first set of starting symbols for SL transmission; a second set of starting symbols and a duration for S-SSB occasion(s); or time domain information indicating whether a slot includes S-SSB occasion(s) or not; and perform a channel access procedure to initiate a channel occupancy time (COT) for SL transmission based on the slot structure information, wherein the COT includes a plurality of consecutive slots; a transmitter coupled to the processor; and a receiver coupled to the processor.

### TECHNICAL FIELD

Embodiments of the present application are related to wireless communication technology, and more particularly, related to methods and apparatuses for sidelink (SL) transmission and SL synchronization signal block (S-SSB) transmission in unlicensed spectra.

### BACKGROUND

A sidelink is a long-term evolution (LTE) feature introduced in 3rd generation partnership project (3GPP) Release 12, and enables a direct communication between proximal user equipments (UEs), in which data does not need to go through a base station (BS) or a core network. A sidelink communication system has been introduced into 3GPP 5G wireless communication technology, in which a direct link between two UEs is called a sidelink.

Sidelink synchronization information is carried in an S-SSB. In an unlicensed spectrum, the SL transmission and S-SSB transmission may be multiplexed in some cases. Therefore, new designs for SL transmission and S-SSB transmission in unlicensed spectra are needed.

### SUMMARY OF THE APPLICATION

Embodiments of the present application at least provide a technical solution for SL transmission and S-SSB transmission in unlicensed spectra.

According to some embodiments of the present application, a UE may include: a processor configured to: obtain slot structure information for an unlicensed spectrum based on configuration or pre-configuration, wherein the slot structure information includes at least one of the following: a first set of starting symbols for SL transmission; a second set of starting symbols and a duration for S-SSB occasion(s); or time domain information indicating whether a slot includes S-SSB occasion(s) or not; and perform a channel access procedure to initiate a channel occupancy time (COT) for SL transmission based on the slot structure information, wherein the COT includes a plurality of consecutive slots; a transmitter coupled to the processor; and a receiver coupled to the processor.

In some embodiments of the present application, the slot structure information is based on at least one of the following granularities: per channel bandwidth, per carrier, per bandwidth part (BWP), per frequency range, or per subcarrier spacing (SCS).

In some embodiments of the present application, the receiver is configured to receive the slot structure information via at least one of: a master information block (MIB) message, a system information block (SIB) message, a radio resource control (RRC) signaling, a medium access control (MAC) control element (CE), or downlink control information (DCI).

In some embodiments of the present application, at least one slot in the COT includes S-SSB occasion(s).

In some embodiments of the present application, the slot structure information indicates a maximum duration of S-SSBs allowed within a COT for SL transmission.

In some embodiments of the present application, at least one slot in the COT includes both an S-SSB occasion and time domain resource(s) for SL transmission, and the time domain resource(s) for SL transmission is located prior to the S-SSB occasion.

In some embodiments of the present application, in the case that S-SSB and physical sidelink feedback channel (PSFCH) are configured periodically within a resource pool for SL transmission, the slot structure information further indicates slot(s) including S-SSB occasion(s), wherein the S-SSB occasion(s) is not allowed to be overlapping with location(s) of PSFCH in the slot(s); in the case that S-SSB is configured periodically within a resource pool for SL transmission while PSFCH is not configured periodically within a resource pool for SL transmission, the transmitter is configured to transmit an indication indicating location(s) of PSFCH which does not overlap with S-SSB occasion(s); or the slot structure information further includes an indication indicating whether a location is used for S-SSB or PSFCH when a collision between S-SSB and PSFCH occurs at the location.

In some embodiments of the present application, the indication indicating whether a location is used for S-SSB or PSFCH is based on a priority of S-SSB or PSFCH or is defined as a default value.

In some embodiments of the present application, at least one slot in the COT includes both an S-SSB occasion and time domain resource(s) for SL transmission, and the S-SSB occasion is located prior to the time domain resource(s) for SL transmission.

In some embodiments of the present application, the slot structure information further includes at least one of: an indicator indicating whether it is enabled or disabled to occupy an S-SSB occasion by a non-S-SSB transmission; or a parameter indicating a duration to identity whether an S-SSB occasion is used or not.

In some embodiments of the present application, the processor is further configured to: in the case that the indicator indicates that it is enabled to occupy an S-SSB occasion by a non-S-SSB transmission, determine a third set of starting symbols for SL transmission within a slot based on the first set of starting symbols and the second set of starting symbols; or in the case that the indicator indicates that it is disabled to occupy an S-SSB occasion by a non-S-SSB transmission, determine the third set of starting symbols for SL transmission within a slot to be the first set of starting symbols.

In some embodiments of the present application, in the case that the indicator indicates that it is enabled to occupy an S-SSB occasion by a non-S-SSB transmission and the UE does not intend to transmit an S-SSB on an S-SSB occasion within a slot of the at least one slot, the processor is further configured to: perform a sensing operation from the beginning of the S-SSB occasion within the duration indicated by the parameter; in response to determining that the S-SSB occasion is not used, perform at least one of the following operations: performing a non-S-SSB transmission until the end of the S-SSB occasion; or performing an SL transmission until the end of the slot including the S-SSB occasion.

In some embodiments of the present application, in the case that at least one slot in the plurality of consecutive slots includes S-SSB occasion(s), the transmitter is further configured to perform at least one of the following steps: transmitting an SL transmission in a first slot within the COT in response to determining that a channel is available for access prior to the first slot based on the channel access procedure; transmitting an SL transmission in a slot within the COT other than the first slot in response to determining that a channel is available for access prior to the SL transmission based on a listen before talk (LBT) type 2 procedure associated with the SL transmission; or transmitting an S-SSB transmission on an S-SSB occasion in a slot within the COT or skip the S-SSB occasion in the slot.

According to some other embodiments of the present application, a UE may include: a processor configured to: obtain slot structure information for an unlicensed spectrum based on configuration or pre-configuration, wherein the slot structure information includes at least one of the following: a first set of starting symbols for SL transmission; a second set of starting symbols and a duration for S-SSB occasion(s); or time domain information indicating whether a slot includes S-SSB occasion(s) or not; a receiver coupled to the processor and configured to receive SL transmission(s) based on the slot structure information; and a transmitter coupled to the processor.

In some embodiments of the present application, the slot structure information is based on at least one of the following granularities: per channel bandwidth, per carrier, per bandwidth part, per frequency range, or per SCS.

In some embodiments of the present application, the receiver is configured to receive the slot structure information via at least one of: a MIB message, a SIB message, an RRC signaling, a MAC CE, or DCI.

In some embodiments of the present application, the slot structure information indicates a maximum duration of S-SSBs allowed within a COT for SL transmission.

In some embodiments of the present application, in the case that S-SSB and PSFCH are configured periodically within a resource pool for SL transmission, the slot structure information further indicates slot(s) including S-SSB occasion(s), wherein the S-SSB occasion(s) is not allowed to be overlapping with location(s) of PSFCH in the slot(s); in the case that S-SSB is configured periodically within a resource pool for SL transmission while PSFCH is not configured periodically within a resource pool for SL transmission, the receiver is configured to receive an indication indicating location(s) of PSFCH which does not overlap with S-SSB occasion(s); or the slot structure information further includes an indication indicating whether a location is used for S-SSB or PSFCH when a collision between S-SSB and PSFCH occurs at the location.

In some embodiments of the present application, the indication indicating whether a location is used for S-SSB or PSFCH is based on a priority of S-SSB or PSFCH or is defined as a default value.

In some embodiments of the present application, the slot structure information further includes at least one of: an indicator indicating whether it is enabled or disabled to occupy an S-SSB occasion by a non-S-SSB transmission; or a parameter indicating a duration to identity whether an S-SSB occasion is used or not.

In some embodiments of the present application, the processor is further configured to: in the case that the indicator indicates that it is enabled to occupy an S-SSB occasion by a non-S-SSB transmission, determine a third set of starting symbols for SL transmission within a slot based on the first set of starting symbols and the second set of starting symbols; or in the case that the indicator indicates that it is disabled to occupy an S-SSB occasion by a non-S-SSB transmission, determine the third set of starting symbols for SL transmission within a slot to be the first set of starting symbols; and the receive is further configured to receive the SL transmission(s) based on the third set of starting symbols.

According to some other embodiments of the present application, a BS may include: a transmitter configured to: transmit slot structure information for an unlicensed spectrum, wherein the slot structure information includes at least one of the following: a first set of starting symbols for SL transmission; a second set of starting symbols and a duration for S-SSB occasion(s); or time domain information indicating whether a slot includes S-SSB occasion(s) or not; a processor coupled to the transmitter; and a receiver coupled to the processor.

In some embodiments of the present application, the slot structure information is based on at least one of the following granularities: per channel bandwidth, per carrier, per bandwidth part, per frequency range, or per SCS.

In some embodiments of the present application, the transmitter is configured to transmit the slot structure information via at least one of: a MIB message, a SIB message, an RRC signaling, a MAC CE, or DCI.

In some embodiments of the present application, the slot structure information indicates a maximum duration of S-SSBs allowed within a COT for SL transmission.

In some embodiments of the present application, in the case that S-SSB and PSFCH are configured periodically within a resource pool for SL transmission, the slot structure information further indicates slot(s) including S-SSB occasion(s), wherein the S-SSB occasion(s) is not allowed to be overlapping with location(s) of PSFCH in the slot(s); or the slot structure information further includes an indication indicating whether a location is used for S-SSB or PSFCH when a collision between S-SSB and PSFCH occurs at the location.

In some embodiments of the present application, the indication indicating whether a location is used for S-SSB or PSFCH is based on a priority of S-SSB or PSFCH or is defined as a default value.

In some embodiments of the present application, the slot structure information further includes at least one of: an indicator indicating whether it is enabled or disabled to occupy an S-SSB occasion by a non-S-SSB transmission; or a parameter indicating a duration to identity whether an S-SSB occasion is used or not.

According to some embodiments of the present application, a method performed by a UE may include: obtaining slot structure information for an unlicensed spectrum based on configuration or pre-configuration, wherein the slot structure information includes at least one of the following: a first set of starting symbols for SL transmission; a second set of starting symbols and a duration for S-SSB occasion(s); or time domain information indicating whether a slot includes S-SSB occasion(s) or not; and performing a channel access procedure to initiate a COT for SL transmission based on the slot structure information, wherein the COT includes a plurality of consecutive slots.

According to some embodiments of the present application, a method performed by a UE may include: obtaining slot structure information for an unlicensed spectrum based on configuration or pre-configuration, wherein the slot structure information includes at least one of the following: a first set of starting symbols for SL transmission; a second set of starting symbols and a duration for S-SSB occasion(s); or time domain information indicating whether a slot includes S-SSB occasion(s) or not; and receiving SL transmission(s) based on the slot structure information.

According to some embodiments of the present application, a method performed by a BS may include: transmitting slot structure information for an unlicensed spectrum, wherein the slot structure information includes at least one of the following: a first set of starting symbols for SL transmission; a second set of starting symbols and a duration for S-SSB occasion(s); or time domain information indicating whether a slot includes S-SSB occasion(s) or not.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary S-SSB slot according to some embodiments of the present application;

FIG. 3 illustrates an exemplary distribution of S-SSB occasions in the time domain according to some embodiments of the present application;

FIG. 4 illustrates a flowchart of an exemplary method for SL transmission and S-SSB transmission according to some embodiments of the present application;

FIG. 5 illustrates an exemplary COT in case 1 according to some embodiments of the present application;

FIG. 6 illustrates an exemplary COT in case 2 according to some embodiments of the present application;

FIG. 7 illustrates an exemplary COT in case 3 according to some embodiments of the present application;

FIG. 8 illustrates an exemplary procedure including an operation for identifying an un-used S-SSB occasion in case 3 according to some embodiments of the present application;

FIG. 9 illustrates a flowchart of an exemplary method for SL transmission and S-SSB transmission according to some other embodiments of the present application; and

FIG. 10 illustrates a simplified block diagram of an exemplary apparatus for SL transmission and S-SSB transmission in an unlicensed spectrum according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G new radio (NR), 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

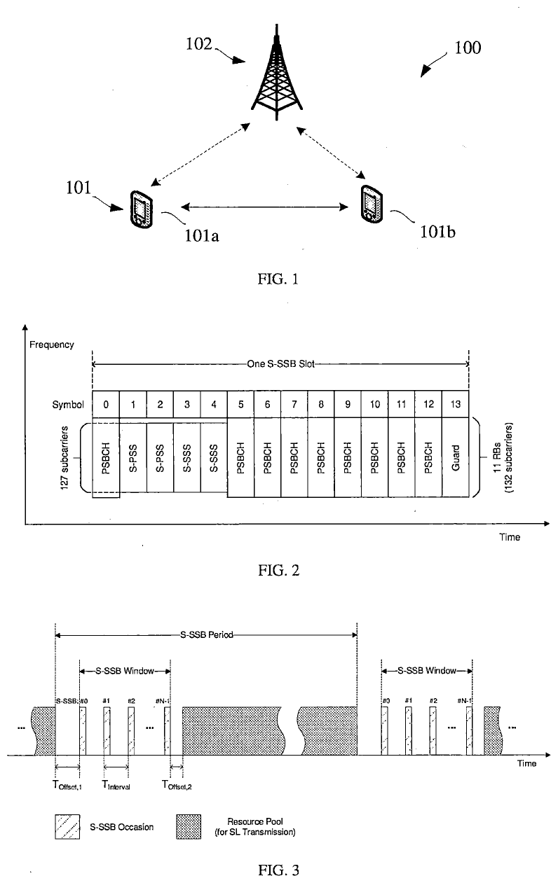

FIG. 1 illustrates an exemplary wireless communication system 100 in accordance with some embodiments of the present application.

As shown in FIG. 1, the wireless communication system 100 includes at least one UE 101 and at least one BS 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

According to some embodiments of the present disclosure, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present disclosure, the UE(s) 101 may include wearable devices, such as smart watches, fitness bands, optical head-mounted displays, or the like.

According to some embodiments of the present disclosure, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present disclosure, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In a sidelink communication system, a transmission UE may also be named as a transmitting UE, a Tx UE, a sidelink Tx UE, a sidelink transmission UE, or the like. A reception UE may also be named as a receiving UE, an Rx UE, a sidelink Rx UE, a sidelink reception UE, or the like.

According to some embodiments of FIG. 1, UE 101a functions as a Tx UE, and UE 101b functions as an Rx UE. UE 101a may exchange sidelink messages with UE 101b through a sidelink, for example, via PC5 interface as defined in 3GPP TS 23.303. UE 101a may transmit information or data to other UE(s) within the sidelink communication system, through sidelink unicast, sidelink groupcast, or sidelink broadcast. For instance, UE 101a may transmit data to UE 101b in a sidelink unicast session. UE 101a may transmit data to UE 101b and other UE(s) in a groupcast group (not shown in FIG. 1) by a sidelink groupcast transmission session. Also, UE 101a may transmit data to UE 101b and other UE(s) (not shown in FIG. 1) by a sidelink broadcast transmission session.

Alternatively, according to some other embodiments of FIG. 1, UE 101b functions as a Tx UE and transmits sidelink messages, and UE 101a functions as an Rx UE and receives the sidelink messages from UE 101b.

In some embodiments of the present disclosure, UE 101a may communicate with UE 101b over licensed spectrums, whereas in other embodiments, UE 101a may communicate with UE 101b over unlicensed spectrums.

Both UE 101a and UE 101b in the embodiments of FIG. 1 may transmit information to BS(s) 102 and receive control information from BS(s) 102, for example, via LTE or NR Uu interface. BS(s) 102 may be distributed over a geographic region. In certain embodiments of the present disclosure, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

In some embodiments of the present disclosure, the wireless communication system 100 is compatible with the 5G NR of the 3GPP protocol, wherein BS(s) 102 transmit data using an orthogonal frequency division multiplexing (OFDM) modulation scheme on the downlink (DL) and UE(s) 101 transmit data on the uplink (UL) using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS(s) 102 may communicate using other communication protocols, such as the IEEE 802.11 family of wireless communication protocols. Further, in some embodiments of the present disclosure, BS(s) 102 may communicate over licensed spectrums, whereas in other embodiments, BS(s) 102 may communicate over unlicensed spectrums. The present disclosure is not intended to be limited to the implementation of any particular wireless communication system architecture or protocol. In yet some embodiments of the present disclosure, BS(s) 102 may communicate with UE(s) 101 using the 3GPP 5G protocols.

In NR, accommodating multiple uncoordinated UEs in an unlicensed spectrum requires channel access procedures defined for NR. Following a successful channel access procedure performed by a communicating node, the channel can be used by the communicating node during a period until the end of the period. Such a period may be referred to as a COT. During a COT, one or more transmissions may be exchanged between the communicating nodes, wherein a transmission may be a downlink transmission or an uplink transmission.

Dynamic channel access procedures are usually used by a BS or a UE to access a channel in an unlicensed spectrum. Dynamic channel access procedures may be based on LBT, where a transmitter listens to potential transmission activity on a channel prior to transmitting and applies a random back-off time in some cases. Two main types of dynamic channel access procedures may be defined in NR. One is Type-1 dynamic channel access procedure, which is also referred to as LBT type 1 or LBT cat4. The other is Type-2 dynamic channel access procedure, which is also referred to as LBT type 2.

Type-1 dynamic channel access procedure may be used to initiate data transmission at the beginning of a COT. The initiator for the Type-1 dynamic channel access procedure may be either a BS or a UE. The Type-1 dynamic channel access procedure may be summarized as follows.

First, the initiator listens and waits until a channel (e.g., a frequency channel) is available during at least one period referred to as a defer duration. The defer duration may consist of 16 μs and a number (e.g., “mₚ” in the following Table 1 or Table 2, which will be illustrated below) of 9 μs slots. As shown in Table 1 and Table 2, a value of “mₚ” depends on a value of channel access priority class (CAPC) (represented as “p”). Accordingly, the defer duration depends on the value of CAPC as shown in the following Table 1 or Table 2. A channel is declared to be available if the received energy during at least 4 μs of each 9 μs slot is below a threshold.

Once the channel has been declared available during the defer duration, the transmitter starts a random back-off procedure during which it will wait a random period of time.

The UE starts the random back-off procedure by initializing a back-off timer with a random number within a contention window (CW). The random number is drawn from a uniform distribution [0, CW] and represents that the channel must be available for a timer duration (e.g., defined by the random number multiplying 9 μs) before transmission can take place. The value of “CW” may be selected from “allowed CWₚ sizes” (the minimum value is represented as CW_{min,p}, and the maximum value is represented as CW_{max,p}) in the following Table 1 or Table 2, which depends on a value of CAPC.

The back-off timer is decreased by one for each sensing slot duration (e.g., 9 μs) the channel is sensed to be idle; whenever the channel is sensed to be busy, the back-off timer is put on hold until the channel has been idle for a defer duration.

Once the back-off timer has expired (e.g., the back-off timer is decreased to be 0), the random back-off procedure is completed, and the transmitter has acquired the channel and can use it for transmission up to MCOT (e.g., T_{m cot,p} in the following Table 1 or T_{ulm cot,p} in the following Table 2, which depends on a value of CAPC).

The following Table 1 and Table 2 illustrate exemplary CAPC for DL and CAPC for UL, respectively, and corresponding values of mₚ, CW_{min,p}, CW_{max,p}, T_{m cot,p}, T_{ulm cot,p}, and allowed CWₚ sizes. Table 1 is the same as Table 4.1.1-1 in TS 37.213 and Table 2 is the same as Table 4.2.1-1 in TS 37.213. When a BS intends to initiate a channel occupancy for DL transmission, it may determine a CAPC value before performing a Type-1 channel access procedure, and then determine the corresponding values (e.g., mₚ, CW_{min,p}, CW_{max,p}, T_{m cot,p}, and allowed CWₚ sizes) used in the Type-1 channel access procedure according to Table 1. When a UE intends to initiate a channel occupancy for UL transmission, it may determine a CAPC value before performing a Type-1 channel access procedure, and then determine the corresponding values (e.g., mₚ, CW_{min,p}, CW_{max,p}, T_{ulm cot,p}, and allowed CWₚ sizes) used in the Type-1 channel access procedure according to Table 2.

TABLE 1
Channel Access Priority Class for DL

| Channel | | | | | |
|---|---|---|---|---|---|
| Access | | | | | |
| Priority | | | | | |
| Class (p) | mₚ | CW_{min, p} | CW_{max, p} | T_{m cot, p} | allowed CWₚsizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 | {15, 31, 63} |
| | | | | ms | |
| 4 | 7 | 15 | 1023 | 8 or 10 | {15, 31, 63, 127, |
| | | | | ms | 255, 511, 1023} |

TABLE 2
Channel Access Priority Class for UL

| Channel | | | | | |
|---|---|---|---|---|---|
| Access | | | | | |
| Priority | | | | | |
| Class (p) | mₚ | CW_{min, p} | CW_{max, p} | T_{ulm cot, p} | allowed CWₚsizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 | {15, 31, 63, 127, |
| | | | | ms | 255, 511, 1023} |
| 4 | 7 | 15 | 1023 | 6 ms or 10 | {15, 31, 63, 127, |
| | | | | ms | 255, 511, 1023} |

NOTE1:
For p = 3, 4, T_{ulm cot, p} = 10 ms if the higher layer parameter ‘absenceOfAnyOtherTechnology-r14’ indicates TRUE, otherwise, T_{ul ulm cot, p} = 6 ms.
NOTE 2:
When T_{ulm cot, p} = 6 ms it may be increased to 8 ms by inserting one or more gaps. The minimum duration of a gap shall be 100 μs. The maximum duration before including any such gap shall be 6 ms.

The size of the contention window may be adjusted based on hybrid automatic repeat request (HARQ) reports received from the transmitter during a reference interval, which covers the beginning of the COT. For each received HARQ report, the contention window is (approximately) doubled up to the limit CW_{max,p} if a negative HARQ report (e.g., non-acknowledgement (NACK)) is received. For a positive HARQ report (e.g., acknowledgement (ACK)), the contention window is reset to its minimum value, i.e., CW=CW_{min,p}.

Type-2 dynamic channel access procedure may be used for COT sharing and transmission of discovery bursts. Depending on a duration of a gap (also referred to as “COT sharing gap”) in the COT, Type-2 dynamic channel access procedure may be further divided into the following three procedures, wherein which procedure to be used may be determined depending on the duration of the gap between two transmission bursts.
Type 2A dynamic channel access procedure (also referred to as LBT cat2 or LBT type 2A): which is used when the gap is 25 μs or more for transmission of the discovery bursts.
Type 2B dynamic channel access procedure (also referred to as LBT type 2B): which is used when the gap is 16 μs.
Type 2C dynamic channel access procedure (also referred to as LBT type 2C): which is used when the gap is 16 μs or less after the preceding transmission burst.

For Type 2C dynamic channel access procedure, no idle sensing is required between the transmission bursts. In such scenario, the duration of a transmission burst is limited to at most 584 μs. Such a short transmission burst may carry small amount of user data, uplink control information (UCI) such as HARQ status reports and channel state information (CSI) reports.

Type 2A dynamic channel access procedure and Type 2B dynamic channel access procedure may be similar to Type-1 dynamic channel access procedure but without the random back-off. That is, in Type 2A dynamic channel access procedure and Type 2B dynamic channel access procedure, if a channel is detected to be idle in the gap, it is declared to be available; if it is detected to be busy, the COT sharing has failed and the transmission cannot occur using COT sharing in this COT. If the COT sharing gap is 16 μs, Type 2B dynamic channel access procedure may be used and the channel must be detected to be idle in the 16 μs gap prior to the next transmission burst. If the COT sharing gap is 25 μs or longer, Type 2A dynamic channel access procedure may be used and the channel must be detected to be idle during at least 25 us immediately preceding the next transmission burst.

The above embodiments provide several dynamic channel access procedures in an unlicensed spectrum for NR. These dynamic channel access procedures may also apply for sidelink transmissions in an unlicensed spectrum.

Sidelink synchronization information is carried in an S-SSB that consists of physical sidelink broadcast channel (PSBCH), sidelink primary synchronization signal (S-PSS) and sidelink secondary synchronization signal (S-SSS). FIG. 2 illustrates an exemplary S-SSB slot according to some embodiments of the present disclosure. In the embodiments of FIG. 2, a normal cyclic prefix (CP) is used.

Referring to FIG. 2, an S-SSB occupies one slot in the time domain and occupies 11 resource blocks (RBs) in the frequency domain. Each RB spans 12 subcarriers, thus the S-SSB bandwidth is 132 (11×12) subcarriers. In the example of FIG. 2, the S-SSB slot may include 14 OFDM symbols in total, e.g., symbol #0 to symbol #13. The S-PSS is transmitted repeatedly on the second and third symbols in the S-SSB slot, e.g., symbol #1 and symbol #2. The S-SSS is transmitted repeatedly on the fourth and fifth symbols in the S-SSB slot, e.g., symbol #3 and symbol #4. The S-PSS and the S-SSS occupy 127 subcarriers in the frequency domain, which are from the third subcarrier relative to the start of the S-SSB bandwidth up to the 129th subcarrier.

The S-PSS and the S-SSS are jointly referred to as the sidelink synchronization signal (SLSS). The SLSS is used for time and frequency synchronization. By detecting the SLSS sent by a synchronization reference UE (also referred to as a SyncRef UE), a UE is able to synchronize to the SyncRef UE and estimate the beginning of the frame and carrier frequency offsets.

The S-PSS may be generated from the maximum length sequences (m-sequences) that use the same design (i.e., generator polynomials, initial values and cyclic shifts, etc.) which is used for generating the m-sequences in the primary synchronization signal (PSS) in the 3GPP documents. In NR Uu, there are three candidate sequences for PSS. However, only two candidate sequences are used for S-PSS.

The S-SSS may be generated from the Gold sequences that use the same design (i.e., generator polynomials, initial values and cyclic shifts, etc.) which is utilized for generating the Gold sequences for the secondary synchronization signal (SSS) in the 3GPP documents. This results in 336 candidate sequences for S-SSS like for the SSS in NR Uu.

For the transmission of SLSS within an S-SSB, a SyncRef UE may select an S-PSS and an S-SSS out of the candidate sequences based on an SLSS identifier (ID). The SLSS ID represents an identifier of the SyncRef UE and conveys a priority of the SyncRef UE as in LTE V2X. Each SLSS ID corresponds to a unique combination of an S-PSS and an S-SSS out of the 2 S-PSS candidate sequences and the 336 S-SSS candidate sequences.

The main purpose of the PSBCH is to provide system-wide information and synchronization information that is required by a UE for establishing a sidelink connection. In the example of FIG. 2, the PSBCH is transmitted on the first symbol (e.g., symbol #0) and the eight symbols (e.g., symbol #5 to symbol #12) after the S-SSS in the S-SSB slot. In the case that an extended CP is used, the PSBCH is transmitted on the first symbol and the six symbols after the S-SSS in the S-SSB slot. The PSBCH occupies 132 subcarriers in the frequency domain. The PSBCH in the first symbol of the S-SSB slot is used for automatic gain control (AGC). The last symbol, e.g., symbol #13, in the S-SSB slot is used as a guard symbol.

A UE may be configured with a configuration for an S-SSB period including one or more S-SSB occasions.

FIG. 3 illustrates an exemplary distribution of S-SSB occasions in the time domain according to some embodiments of the present disclosure.

In the example of FIG. 3, one S-SSB window is included in one S-SSB period. It is contemplated that more S-SSB windows can be included in one S-SSB period in other examples. The S-SSB period may also include resource(s) for SL transmission, which does not overlap with the S-SSB window in the time domain. A resource pool may define the overall time and frequency domain resources that can be used for SL transmission within a carrier. In other words, the resource(s) for SL transmission in the S-SSB period is in the resource pool. The SL transmission in the embodiments of the present disclosure may refer to at least one of: physical sidelink control channel (PSCCH) or physical sidelink shared channel (PSSCH). In the time domain, the resource pool consists of a set of slots repeated over a resource pool period. Although the set of slots within the resource pool are logically organized in a consecutive way, actually the slots within the resource pool may be discretely distributed in the time domain.

As shown in FIG. 3, in the S-SSB window, N S-SSB occasions are included, which are S-SSB occasion #0, S-SSB occasion #1, . . . , S-SSB occasion #N−1, respectively.

A length of the S-SSB period is marked as “S-SSB Period” in FIG. 3. There is an offset between the starting of the S-SSB period and the starting of the S-SSB window, which is marked as “T_{Offset,1}” in FIG. 3. There is another offset between the end of the S-SSB window and the starting of the resource(s) in the resource pool, which is marked as “T_{Offset,2}” in FIG. 3. There is an interval between two adjacent S-SSB occasions (e.g., between starting slots of the two adjacent S-SSB occasions), which is marked as “T_{Interval}” in FIG. 3. Accordingly, the configuration for one S-SSB period may include at least one of the parameter “S-SSB Period,” the parameter “T_{Offset,1},” the parameter “T_{Interval},” or a parameter “N” indicating the number of S-SSB occasions within one S-SSB window (or one S-SSB period).

In 3GPP Release 16 (Rel-16) or Release 17 (Rel-17), the S-SSB period may include 160 ms, as specified in NR V2X. However, along with developments of network architectures and new service scenarios, the S-SSB period may have other values, which should not affect the principle of the disclosure.

The structure of S-SSB slot in FIG. 2 and distribution of occasions for S-SSB in FIG. 3 are only for illustrative purpose. It is contemplated that along with developments of network architectures and new service scenarios, the S-SSB may have other structures (for example, the S-SSB may include 4 OFDM symbols or 6 OFDM symbols in the time domain) and the distribution of occasions for S-SSB within one S-SSB period or within one window may change, which should not affect the principle of the present application.

In some cases of the present disclosure, the S-SSB is not frequency multiplexed with any other SL physical channel (e.g., PSCCH or PSSCH) within the SL BWP, i.e., S-SSBs are not transmitted in the slots of a resource pool.

As a feature in an unlicensed band, COT-based transmission is promising to be applied in sidelink. Considering the NR Uu link in an unlicensed band, the length of MCOT may be up to 10 ms. Accordingly, there may be a case where an S-SSB occasion is multiplexed with an SL transmission slot in the time domain within one COT.

In addition, the following issues are involved in the scope of Release 18 (Rel-18) sidelink study: (1) whether or how to support a shorter S-SSB duration (e.g., the S-SSB duration is less than one slot); (2) whether or how to introduce more S-SSB occasions compared with Rel-16 or Rel-17; and (3) whether or how to support a slot structure, where data transmissions are not constrained to the slot boundaries.

Given the above, new slot structures for SL transmission and S-SSB transmission and the corresponding UE behaviors need to be defined aiming at decreasing the loss of channel access opportunity for a UE during COT-based SL transmission caused by periodic S-SSB occasions.

Embodiments of the present application provide improved solutions for SL transmission and S-SSB transmission in an unlicensed spectrum. For example, embodiments of the present application define a new slot structure for multiplexed S-SSB and SL transmissions within a COT in an unlicensed band. In addition, embodiments of the present application also propose configurations, signalings, and procedures for performing COT-based SL transmission in an unlicensed band. More details will be described in the following text in combination with the appended drawings.

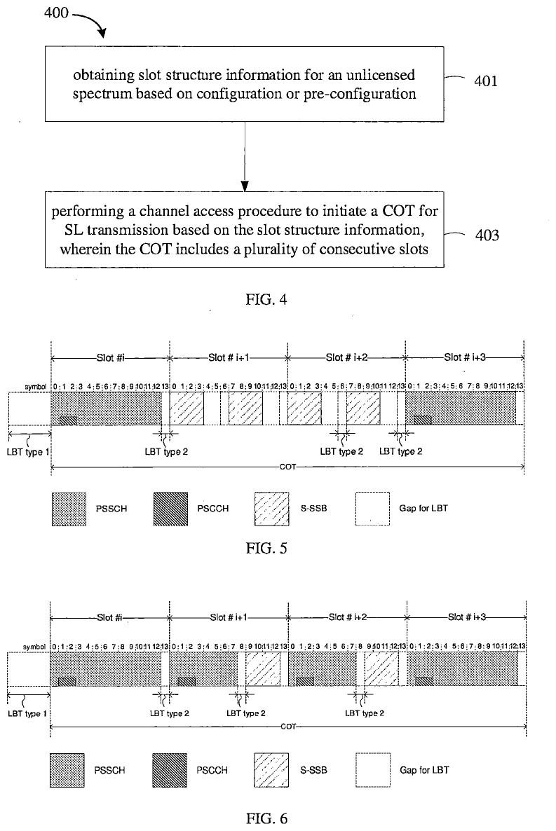

FIG. 4 illustrates a flowchart of an exemplary method 400 for SL transmission and S-SSB transmission according to some embodiments of the present application. The method 400 illustrated in FIG. 4 may be performed by a UE (e.g., UE 101a or UE 101b in FIG. 1) initiating a COT-based SL transmission or other apparatus with the like functions. The UE initiating a COT-based SL transmission may also be referred to as an initiating UE or a COT initiator.

As shown in FIG. 4, in step 401, the UE may obtain slot structure information for an unlicensed spectrum based on configuration or pre-configuration.

In some embodiments of the present application, the UE may obtain the slot structure information based on configuration. Specifically, obtaining the slot structure information based on configuration (i.e., the slot structure information is configured to the UE) may refer to that: the slot structure information is transmitted by a BS (e.g., BS 102 as shown in FIG. 1) to the UE via at least one of: a SIB message, a MIB message, an RRC signaling, or a MAC CE, or DCI, such that the UE may receive the slot structure information from the BS. In an embodiment of the present application, obtaining the slot structure information based on configuration may apply to the scenario where the UE is in coverage of a network.

In some other embodiments of the present application, the UE may obtain the slot structure information based on pre-configuration. Specifically, obtaining the slot structure information based on pre-configuration (i.e., the slot structure information is pre-configured to the UE) may refer to that: the slot structure information may be hard-wired into the UE or stored on a subscriber identity module (SIM) or universal subscriber identity module (USIM) card for the UE, such that the UE may obtain the slot structure information within the UE. In an embodiment of the present application, obtaining the slot structure information based on pre-configuration may apply to the scenario where the UE is out of coverage of the network.

In some embodiments of the present application, the slot structure information is based on at least one of the following granularities: per channel bandwidth, per carrier, per bandwidth part, per frequency range, or per SCS.

The slot structure information for an unlicensed spectrum may include at least one of:
a first set of starting symbols (also referred to as first symbols) for SL transmission: a starting symbol or a first symbol for SL transmission may be defined by an indicator indicating the position of the first symbol of an SL transmission, for example, a first set of starting symbols for SL transmission may be indicated by a set of indices of first symbols for SL transmission;
a second set of starting symbols (also referred to as first symbols) and a duration for S-SSB occasion(s): a starting symbol or a first symbol for an S-SSB occasion may be defined by an indicator indicating the position of the first symbol of the S-SSB occasion, for example, a second set of starting symbols for S-SSB occasion(s) may be indicated by a set of indices of first symbols for S-SSB occasion(s); in some cases, the duration for S-SSB occasion may be one slot including a guard symbol; in some other cases, the duration for S-SSB occasion may be less than one slot (e.g., 4 OFDM symbols or 6 OFDM symbols); or
time domain information indicating whether a slot includes S-SSB occasion(s) or not: for example, the time domain information may be a bitmap, and each bit of the bitmap may correspond to a slot in the resource pool, for example, the value of a bit being “O” indicates that the corresponding slot does not include S-SSB occasion(s) while the value of the bit being “1” indicates that the corresponding slot includes S-SSB occasion(s), or vice versa; in another example, the time domain information may include configuring information for indicating distribution of S-SSB occasions (e.g., the configuration information described with reference to FIG. 3) and configuration information for SL transmission in a resource pool, such that the UE may determine whether a slot includes S-SSB occasion(s) or not based on the above two kinds of configuration information; the time domain information in the above examples is only for illustrative purpose, and it is contemplated that time domain information may be any other information for indicating whether a slot includes S-SSB occasion(s) or not.

In step 403, the UE may perform a channel access procedure to initiate a COT for SL transmission based on the slot structure information. The COT may include a plurality of consecutive slots. The specific operations performed in step 403 will be described in detail below.

The distribution of S-SSB occasions and SL transmission resources in the time domain can be divided into the following three cases (i.e., case 1, case 2, and case 3) by considering whether an S-SSB occasion can be located within a slot for SL transmission or not.

### Case 1

In case 1, an S-SSB occasion cannot be located within a slot for SL transmission. In other words, an S-SSB occasion and an SL transmission are not allowed to be located within the same slot.

In some embodiments of case 1, the duration or an S-SSB occasion may be one slot as shown in FIG. 2. In some other embodiments of case 1, considering the broader bandwidth in an unlicensed band, the duration of an S-SSB occasion (or an S-SSB) may be reduced, and thus the total duration for a given number of S-SSB occasions may be limited to a shorter range. For example, the duration of an S-SSB occasion (or an S-SSB) may be 4 OFDM symbols (i.e., 4 symbols) or 6 OFDM symbols (i.e., 6 symbols). Such an S-SSB occasion (or an S-SSB) may be referred to as a 4-symbol S-SSB occasion (or 4-symbol S-SSB) or a 6-symbol S-SSB occasion (6-symbol S-SSB). Given this, the starting symbol(s) and the duration for S-SSB occasion(s) within a slot may be included the slot structure information obtained in step 401.

Based on the slot structure information, the UE may perform a channel access procedure to initiate a COT for SL transmission in step 403. In some cases, at least one slot in the COT includes S-SSB occasion(s). In some other cases, none of the plurality of consecutive slots in the COT includes S-SSB occasion(s).

FIG. 5 illustrates an exemplary COT in case 1 according to some embodiments of the present application.

Referring to FIG. 5, the UE may perform a channel access procedure (e.g., LBT type 1 procedure) prior to slot #i to initiate a COT for SL transmission starting from slot #i. The COT may include 4 slots, e.g., slot #i, slot #i+1, slot #i+2, and slot #i+3. The UE may determine that slot #i+1 and slot #i+2 include S-SSB occasions, for example, based on the time domain information included in the slot structure information.

In the example of FIG. 5, the slot structure information may indicate that: the first set of starting symbols for SL transmission includes symbol #0, the second set of starting symbols for S-SSB occasion(s) includes symbol #0 and symbol #7, and the duration for S-SSB occasion is 4 symbols. Accordingly, based on the above information, the UE may determine the distribution of S-SSB occasions as shown in FIG. 5.

Referring to FIG. 5, it can be seen that a problem for the slot structure in case 1 is that it is easy for the UE to lose the channel access opportunity due to a long interruption caused by S-SSB occasions.

One possible solution to solve the above problem is to impose a constraint on the maximized length of S-SSB occasions allowed within a COT for SL transmission. The constraint may impact the resource selection when the UE intends to initiate a COT. The following embodiments provide the methods regarding how to implement the constraint.

In some embodiments of the present application, the slot structure information may further indicate a maximum duration of S-SSBs (e.g., denoted by MaxS-SSBInCOTForSL) allowed within a COT for SL transmission. In some examples, the maximum duration may be in units of slots, symbols, millisecond (ms), etc. In some examples, the maximum duration may be in units of S-SSB occasions. Based on the maximum duration, in step 403, the UE may perform a channel access procedure to initiate a COT for SL transmission such that the COT is subject to the maximum duration.

In some cases, the maximum duration may be greater than 0 (e.g., no less than one slot). Then, at least one slot of the COT initiated in step 403 may include S-SSB occasion(s), and a duration of S-SSBs within the COT is no greater than the maximum duration. For example, assuming that the maximum duration is 3 slots, the UE may perform a channel access procedure to initiate a COT (e.g., the COT as illustrated in FIG. 5) in which a duration of S-SSBs within the COT is 2 slots.

In some other cases, the maximum duration may be equal to 0, which means that the COT may not include any S-SSB occasions.

In some other embodiments of the present application, the constraint may be a regulation that there should be no S-SSB occasions included in a COT for SL transmission. Such regulation may be configured or pre-configured for the UE. For example, the slot structure information obtained in step 401 may indicate that a COT for SL transmission does not include any S-SSB occasion. Then, in step 403, the UE may perform a channel access procedure to initiate a COT for SL transmission such that the COT does not include any S-SSB occasion.

In case 1, when the UE intends to initiate a COT-based SL transmission, the UE may perform a procedure at least including the following steps.

In step 1-1, if the UE intends to initiate a COT (in some cases, the COT may be subject to the constraint as stated above) starting from a slot (e.g., slot #i) for SL transmission, the UE may initiate a COT counter (e.g., denoted by N_{C}) with an initial value being Nₛₗₒₜ^{COT} (Slot #i) (i.e., N_{C}=Nₛₗₒₜ^{COT} (Slot #i)), wherein Nₛₗₒₜ^{COT} (Slot #i) indicates the length (e.g., in units of slot) of the COT starting from Slot #i. Then, the UE goes to step 1-2.

In step 1-2, the UE may perform a channel access procedure (e.g., an LBT type 1 procedure) associated with (e.g., towards) slot #i to initiate the COT starting from slot #i. In response to the channel being determined to be available prior to slot #i based on the channel access procedure, the UE goes to step 1-3. Else, in response to the channel access being failed, the UE stops the procedure.

In step 1-3, the UE may transmit an SL transmission on the first available slot based on the corresponding channel access procedure. In addition, in step 1-3, the UE may also decrement N_{C} by one, i.e., set N_{C}=N_{C}−1. In the case that the current value of N_{C} is greater than 0, the UE goes to step 1-4. Else, in the case that the current value of N_{C} is no greater than 0, the UE stops the procedure.

In step 1-4, the UE may determine a type of the next slot, wherein the type of the next slot may indicate whether the next slot is for SL transmission or for S-SSB transmission, in other words, the type of the next slot may indicate whether the next slot includes S-SSB occasion(s) or time domain resource(s) for SL transmission. If the next slot is for SL transmission, the UE goes to step 1-5. Else, if the next slot is for S-SSB transmission, the UE may perform S-SSB transmission in the next slot or skip the next slot, which is according to the UE's intention, and then decrement N_{C} by one, i.e., set N_{C}=N_{C}−1. In the case that the current value of N_{C} is greater than 0, the UE goes to step 1-4. Else, in the case that the current value of N_{C} is no greater than 0, the UE stops the procedure.

In step 1-5, the UE may perform an LBT type 2 procedure associated with the next slot. In response to the channel being determined to be available prior to the next slot based on the LBT type 2 procedure, the UE goes to step 1-3. Else, in response to the channel access being failed, the UE stops the procedure.

### Case 2

In case 2, an S-SSB occasion and an SL transmission can be located within a slot, and the time domain resource(s) for SL transmission may be located prior to the S-SSB occasion within the slot.

In case 2, since the S-SSB occasion and the SL transmission can be located within a slot, the maximized gap between two adjacent SL transmissions can be limited to be about the length of an S-SSB occasion. Accordingly, the slot structure in case 2 may solve the aforementioned problem in case 1.

In case 2, the duration of an S-SSB occasion (or an S-SSB) may be less than one slot. For example, the duration of an S-SSB occasion (or an S-SSB) may be 4 OFDM symbols (i.e., 4 symbols) or 6 OFDM symbols (i.e., 6 symbols). Given this, the starting symbol(s) and the duration for S-SSB occasion(s) within a slot may be included in the slot structure information obtained in step 401.

Based on the slot structure information, the UE may perform a channel access procedure to initiate a COT for SL transmission in step 403. In some cases, at least one slot within the COT may include both an S-SSB occasion and time domain resource(s) for SL transmission, and the time domain resource(s) for SL transmission is located prior to the S-SSB occasion. In some other cases, none of the plurality of consecutive slots in the COT includes S-SSB occasion(s).

FIG. 6 illustrates an exemplary COT in case 2 according to some embodiments of the present application.

Referring to FIG. 6, the UE may perform a channel access procedure (e.g., LBT type 1 procedure) prior to slot #i to initiate a COT for SL transmission starting from slot #i. The COT may include 4 slots, e.g., slot #i, slot #i+1, slot #i+2, and slot #i+3. The UE may determine that slot #i+1 and slot #i+2 include S-SSB occasions, for example, based on the time domain information included in the slot structure information.

In the example of FIG. 6, the slot structure information may indicate that: the first set of starting symbols for SL transmission includes symbol #0, the second set of starting symbols for S-SSB occasion(s) includes symbol #9, and the duration for S-SSB occasion is 4 symbols. Accordingly, based on the above information, the UE may determine the distribution of S-SSB occasions as shown in FIG. 6.

Referring to FIG. 6, it can be seen that a problem for the slot structure in case 2 is that a collision between S-SSB occasion and PSFCH may occur because both the S-SSB occasion and the PSFCH are near the end of a slot. The following embodiments may provide methods for solving the above problem.

In some embodiments, the S-SSB and PSFCH may be configured periodically within a resource pool for SL transmission. In such embodiments, the slot structure information may also indicate slot(s) including S-SSB occasion(s), wherein the S-SSB occasion(s) is not allowed to be overlapping with location(s) of PSFCH in the slot(s).

In some embodiments, the S-SSB may be configured periodically within a resource pool for SL transmission while PSFCH may be not configured periodically within a resource pool for SL transmission. In such embodiments, the UE may transmit an indication indicating location(s) for PSFCH which does not overlap with S-SSB occasion(s).

In some embodiments, the UE may further obtain, based on configuration or pre-configuration, an indication indicating whether a location is used for S-SSB or PSFCH when a collision between S-SSB and PSFCH occurs at the location. For example, the indication may be included in the slot structure information obtained in step 401.

In an embodiment, the indication may be based on a priority of S-SSB or PSFCH. For example, in the case that S-SSB is prioritized over PSFCH, the indication may indicate that the location is used for S-SSB when a collision between S-SSB and PSFCH occurs at the location. In the case that PSFCH is prioritized over S-SSB, the indication may indicate that the location is used for PSFCH when a collision between S-SSB and PSFCH occurs at the location.

In another embodiment, the indication may be defined as a default value, and the default value may indicate whether a location is used for S-SSB or PSFCH when a collision between S-SSB and PSFCH occurs at the location. For example, the default value may be “0,” which indicates that a location is used for S-SSB when a collision between S-SSB and PSFCH occurs at the location, or the default value may be “1,” which indicates that a location is used for PSFCH when a collision between S-SSB and PSFCH occurs at the location.

In the above embodiments, a location of PSFCH may refer to a symbol for PSFCH or a slot for PSFCH.

In case 2, when the UE intends to initiate a COT-based SL transmission, the UE may perform a procedure at least including the following steps.

In step 2-1, if the UE intends to initiate a COT starting from a slot (e.g., slot #i) for SL transmission, the UE may initiate a COT counter (e.g., denoted by N_{C}) with an initial value being Nₛₗₒₜ^{COT} (Slot #i) (i.e., N_{C}=Nₛₗₒₜ^{COT} (Slot #i)), wherein Nₛₗₒₜ^{COT} (Slot #i) indicates the length (e.g., in units of slot) of the COT starting from Slot #i. Then, the UE goes to step 2-2.

In step 2-2, the UE may perform a channel access procedure (e.g., an LBT type 1 procedure) associated with (e.g., towards) slot #i to initiate the COT starting from slot #i. In response to the channel being determined to be available prior to slot #i based on the channel access procedure, the UE goes to step 2-3. Else, in response to the channel access being failed, the UE stops the procedure.

In step 2-3, the UE may transmit an SL transmission on the first available slot based on the corresponding channel access procedure. In addition, in step 2-3, the UE may also decrement N_{C} by one, i.e., set N_{C}=N_{C}−1. In the case that the current value of N_{C} is greater than 0, the UE goes to step 2-4. Else, in the case that the current value of N_{C} is no greater than 0, the UE stops the procedure.

In step 2-4, the UE may determine a type of the next slot, wherein the type of the next slot may indicate whether the next slot is for SL transmission or for both SL transmission and S-SSB transmission, in other words, the type of the next slot may indicate whether the next slot only includes time domain resource(s) for SL transmission or includes S-SSB occasion(s). If the next slot is for SL transmission, the UE goes to step 2-5; else, if the next slot is for both SL transmission and S-SSB transmission, the UE goes to step 2-6.

In step 2-5, the UE may perform an LBT type 2 procedure associated with an SL transmission in the next slot. In response to the channel being available for access prior to the next slot based on the LBT type 2 procedure, the UE goes to step 2-3. Else, in response to the channel access being failed, the UE stops the procedure

In step 2-6, the UE may perform an LBT type 2 procedure associated with an SL transmission in the next slot. In response to the channel being available for access prior to the next slot based on the LBT type 2 procedure, the UE may perform the SL transmission. Else, in response to the channel access being failed, the UE stops the procedure.

In step 2-6, after performing the SL transmission, the UE may further perform S-SSB transmission(s) in the same slot (e.g., following an S-SSB transmission procedure) or skip the S-SSB transmission(s), which is according to the UE's intention. In some embodiments, the S-SSB transmission procedure may include performing an LBT type 2 procedure associated with an S-SSB occasion before performing an S-SSB transmission on the S-SSB occasion.

In step 2-6, after performing or skipping the S-SSB transmission(s), by the end of the transmission occasions in the slot, the UE may decrement N_{C} by one, i.e., set N_{C}=N_{C}−1. In the case that the current value of N_{C} is greater than 0, the UE goes to step 2-4. Else, in the case that the current value of N_{C} is no greater than 0, the UE stops the procedure.

### Case 3

In case 3, an S-SSB occasion and an SL transmission can be located within a slot, and the S-SSB occasion may be located prior to the time domain resource(s) for SL transmission within the slot.

In case 3, since the S-SSB occasion and the SL transmission can be located within a slot, the maximized gap between two adjacent SL transmissions can be limited to be about the length of an S-SSB occasion. Accordingly, the slot structure in case 3 may solve the aforementioned problem in case 1. In addition, since the S-SSB occasion is located in the front part of a slot, the slot structure of case 3 can avoid the possible collision between S-SSB and PSFCH in case 2.

In case 3, the SL transmission may have different starting symbols in different slots. Accordingly, the different starting symbols for SL transmission may be included in the slot structure information obtained in step 401. In addition, the duration of an S-SSB occasion (or an S-SSB) in case 3 may be less than one slot. For example, the duration of an S-SSB occasion (or an S-SSB) may be 4 OFDM symbols (i.e., 4 symbols) or 6 OFDM symbols (i.e., 6 symbols). Given this, the duration for S-SSB occasion(s) may be included the slot structure information obtained in step 401.

Based on the slot structure information, the UE may perform a channel access procedure to initiate a COT for SL transmission in step 403. In some cases, at least one slot in the COT may include both an S-SSB occasion and time domain resource(s) for SL transmission, and the S-SSB occasion is located prior to the time domain resource(s) for SL transmission. In some other cases, none of the plurality of consecutive slots in the COT includes S-SSB occasion(s).

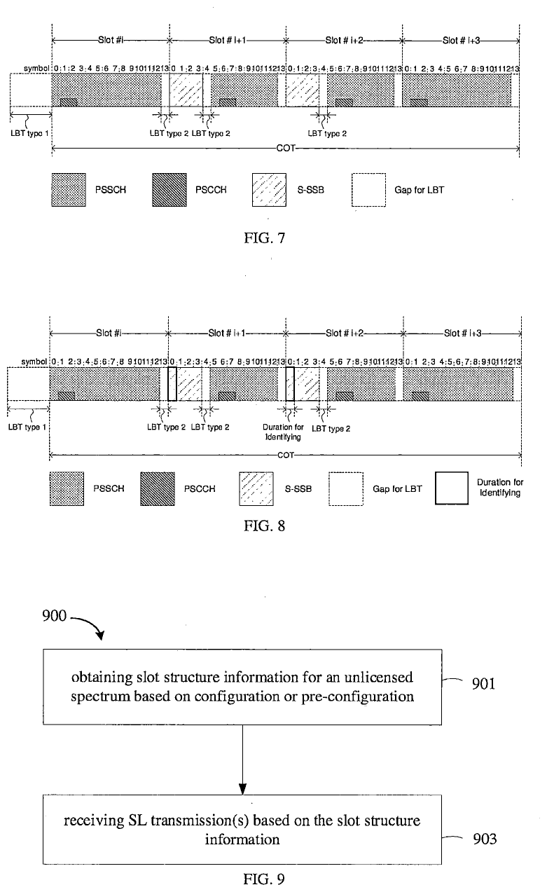

FIG. 7 illustrates an exemplary COT in case 3 according to some embodiments of the present application.

Referring to FIG. 7, the UE may perform a channel access procedure (e.g., LBT type 1 procedure) prior to slot #i to initiate a COT for SL transmission starting from slot #i. The COT may include 4 slots, e.g., slot #i, slot #i+1, slot #i+2, and slot #i+3. The UE may determine that slot #i+1 and slot #i+2 include S-SSB occasions, for example, based on the time domain information included in the slot structure information.

In the example of FIG. 7, the slot structure information may indicate that: the first set of starting symbols for SL transmission includes symbol #0 and symbol #5, wherein symbol #0 may be a starting symbol of an SL transmission in slot(s) (e.g., slot #i and slot #i+3) only including SL transmission whereas symbol #5 may be a starting symbol of an SL transmission in slot(s) (e.g., slot #i+1 and slot #i+2) including both SL transmission and S-SSB occasion; the second set of starting symbols for S-SSB occasion(s) includes symbol #0; and the duration for S-SSB occasion is 4 symbols. Accordingly, based on the above information, the UE may determine the distribution of S-SSB occasions as shown in FIG. 7.

In case 3, when the UE intends to initiate a COT-based SL transmission, the UE may perform a procedure at least including the following steps.

In step 3-1, if the UE intends to initiate a COT starting from a slot (e.g., slot #i) for SL transmission, the UE may initiate a COT counter (e.g., denoted by N_{C}) with an initial value being Nₛₗₒₜ^{COT} (Slot #i) (i.e., N_{C}=Nₛₗₒₜ^{COT} (Slot #i)), wherein Nₛₗₒₜ^{COT} (Slot #i) indicates the length (e.g., in units of slot) of the COT starting from Slot #i. Then, the UE goes to step 3-2.

In step 3-2, the UE may perform a channel access procedure (e.g., an LBT type 1 procedure) associated with (e.g., towards) slot #i to initiate the COT starting from slot #i. In response to the channel being determined to be available prior to slot #i based on the channel access procedure, the UE goes to step 3-3. Else, in response to the channel access being failed, the UE stops the procedure.

In step 3-3, the UE may transmit an SL transmission on the first available slot based on the corresponding channel access procedure. In addition, in step 3-3, the UE may also decrement N_{C} by one, i.e., set N_{C}=N_{C}−1. In the case that the current value of N_{C} is greater than 0, the UE goes to step 3-4. Else, in the case that the current value of N_{C} is no greater than 0, the UE stops the procedure.

In step 3-4, the UE may determine a type of the next slot, wherein the type of the next slot may indicate whether the next slot is for SL transmission or for both SL transmission and S-SSB transmission, in other words, the type of the next slot may indicate whether the next slot only includes time domain resource(s) for SL transmission or includes S-SSB occasion(s). If the next slot is for SL transmission, the UE goes to step 3-5; else, if the next slot is for both SL transmission and S-SSB transmission, the UE goes to step 3-6.

In step 3-5, the UE may perform an LBT type 2 procedure associated with an SL transmission in the next slot. In response to the channel being available for access prior to the next slot based on the LBT type 2 procedure, the UE goes to step 3-3. Else, in response to the channel access being failed, the UE stops the procedure

In step 3-6, the UE may perform S-SSB transmission(s) in the next slot (e.g., following an S-SSB transmission procedure) or skip the S-SSB transmission(s), which is according to the UE's intention. In some embodiments, the S-SSB transmission procedure may include performing an LBT type 2 procedure associated with an S-SSB occasion before performing an S-SSB transmission on the S-SSB occasion.

In step 3-6, after performing or skipping the S-SSB transmission, the UE may also perform an LBT type 2 procedure associated with an SL transmission in the same slot. In response to the channel being available for access prior to the starting symbol for SL transmission, the UE may perform the SL transmission. Else, in response to the channel access being failed, the UE stops the procedure.

In step 3-6, after performing the SL transmission, by the end of the transmission occasions in the slot, the UE may decrement N_{C} by one, i.e., set N_{C}=N_{C}−1. In the case that the current value of N_{C} is greater than 0, the UE goes to step 3-4. Else, in the case that the current value of N_{C} is no greater than 0, the UE stops the procedure.

In some embodiments of case 3, an enhancement in guaranteeing channel access opportunity for a COT-based SL transmission may be achieved by occupying the channel when identifying an S-SSB occasion before an SL transmission is un-used.

In such embodiments, the slot structure information may further include at least one of:
an indicator (e.g., S-SSBOccupiedByNon-S-SSB or S-SSBOccupiedBySL) indicating whether it is enabled or disabled to occupy an S-SSB occasion by a non-S-SSB transmission (e.g., dummy data, SL transmission, etc.): in some cases, the indicator may be realized as defining a UE behavior, for example, the UE may drop an SL transmission if it is overlapping with an S-SSB occasion; or
a parameter indicating a duration to identity whether an S-SSB occasion is used or not: in some embodiments, the identification regarding whether an S-SSB occasion is used or not may be done by such as sensing, LBT, or other methods; in some embodiments, the duration may be expressed in units of symbols, for example, the parameter may be denoted as

$${N}_{symbol}^{identify} ,$$

which is the number of symbols included in the duration; for example,

$${N}_{symbol}^{identify}$$

may be set to 1, which means that the duration includes 1 symbol.

Based on the above information, the UE may determine a third set of starting symbols for SL transmission, which is used by the UE to perform SL transmissions.

Specifically, in the case that the indicator indicates that it is enabled to occupy an S-SSB occasion by a non-S-SSB transmission, the UE may determine the third set of starting symbols for SL transmission within a slot based on the first set of starting symbols for SL transmission and the second set of starting symbols for S-SSB occasion(s). In the case that the indicator indicates that it is disabled to occupy an S-SSB occasion by a non-S-SSB transmission, the UE may determine (or set) the third set of starting symbols for SL transmission within a slot as same as the first set of starting symbols for SL transmission.

For example, it is assumed that the first set of starting symbols (e.g., denoted by Set1) for SL transmission indicates the set of indices of starting symbols for SL transmission. For example, Set1={0, 5, 7}, wherein symbol #0 may be a starting symbol of an SL transmission in a slot only including SL transmission, symbol #5 may be a starting symbol of an SL transmission in a slot which includes an S-SSB occasion whose duration is 4 symbols, and symbol #7 may be a starting symbol of an SL transmission in a slot which includes an S-SSB occasion whose duration is 6 symbols.

Moreover, it is assumed that the second set of starting symbols (e.g., denoted by Set2) for S-SSB occasion(s) indicates the set of indices of starting symbols for S-SSB occasion. For example, Set2={0}, which means that the starting symbol of an S-SSB occasion is symbol #0.

When S-SSBOccupiedBySL (e.g., with a value of “0”) indicates that it is disabled to occupy an S-SSB occasion by a non-S-SSB transmission, the UE may set Set3=Set1, wherein Set3 is the third set of starting symbols for SL transmission.

When S-SSBOccupiedBySL (e.g., with a value of “1”) indicates that it is enabled to occupy an S-SSB occasion by a non-S-SSB transmission, the UE may set

$$Set 3 = Set 1 ⋃ {\{ i \vert i = j + {N}_{symbol}^{identify} \}}_{j ∈ S e t 2} .$$

Assuming that

$${N}_{symbol}^{identify} = 1 , Set 3 = \{ 0 , 1 , 5 , 7 \} .$$

That is to say, if an S-SSB occasion is declared to be idle by an identification operation within a duration including

$${N}_{symbol}^{identify}$$

symbols, the UE may transmit an SL transmission from a symbol immediately after the identification operation.

In such embodiments, the S-SSB transmission and the SL transmission within a slot in the above procedure in case 3 may change. For example, the operations in step 3-6 may change.

For example, in the case that the indicator indicates that it is enabled to occupy an S-SSB occasion by a non-S-SSB transmission and the UE does not intend to transmit an S-SSB on an S-SSB occasion within a slot including both an S-SSB occasion and time domain resource(s) for SL transmission, the UE may perform at least one of the following steps with respect to the S-SSB occasion.

In step 4-1, the UE may perform an LBT type 2 procedure associated with the S-SSB occasion. In response to determining that a channel is available for access prior to the S-SSB occasion based on the LBT type 2 procedure, the UE goes to step 4-2. Else, in response to the channel access being failed, the UE may skip the S-SSB occasion.

In step 4-2, the UE may perform a sensing operation from the beginning of the S-SSB occasion within a duration (e.g.,

$${N}_{symbol}^{sensing}$$

symbols) indicated by the parameter indicating a duration to identity whether an S-SSB occasion is used or not. In response to determining that the S-SSB occasion is not used (e.g., the channel is declared to be idle), the UE goes to step 4-3. Else, the UE may skip the S-SSB occasion.

In step 4-3, the UE may perform a non-S-SSB transmission until the end of the S-SSB occasion. Alternatively or additionally, the UE may perform an SL transmission until the end of the slot including the S-SSB occasion.

FIG. 8 illustrates an exemplary procedure including an operation for identifying an un-used S-SSB occasion in case 3 according to some other embodiments of the present application

All the assumptions in FIG. 7 may apply to FIG. 8. In addition, it is further assumed that the slot structure information includes an indicator indicating that it is enabled to occupy an S-SSB occasion by a non-S-SSB transmission, and further includes a parameter indicating that the duration to identity whether an S-SSB occasion is used or not is 1 symbol.

Referring to FIG. 8, prior to an S-SSB occasion (e.g., S-SSB occasion in slot #i+1 or S-SSB occasion in slot #i+2), the UE may perform an LBT type 2 procedure associated with the S-SSB occasion. In response to determining that a channel is available for access prior to the S-SSB occasion based on the LBT type 2 procedure, and the UE does not intend to transmit an S-SSB on the S-SSB occasion, the UE may perform a sensing operation or an LBT within the first symbol in the S-SSB occasion. In response to determining that the S-SSB occasion is not used (e.g., the channel is declared to be idle), the UE may transmit a non-S-SSB transmission (e.g., dummy data) until the end of the S-SSB occasion, or transmit an SL transmission until the end of the corresponding slot.

FIG. 9 illustrates a flowchart of an exemplary method 900 for SL transmission and S-SSB transmission according to some other embodiments of the present application. The method 900 may be performed by a UE (e.g., UE 101a or UE 101b in FIG. 1) receiving an SL transmission from an initiating UE or other apparatus with the like functions. The UE receiving an SL transmission may also be referred to as a receiving UE.

As shown in FIG. 9, in step 901, the UE may obtain slot structure information for an unlicensed spectrum based on configuration or pre-configuration.

In some embodiments of the present application, the UE may obtain the slot structure information based on configuration. Specifically, obtaining the slot structure information based on configuration (i.e., the slot structure information is configured to the UE) may refer to that: the slot structure information is transmitted by a BS (e.g., BS 102 as shown in FIG. 1) to the UE via at least one of: a SIB message, a MIB message, an RRC signaling, or a MAC CE, or DCI, such that the UE may receive the slot structure information from the BS. In an embodiment of the present application, obtaining the slot structure information based on configuration may apply to the scenario where the UE is in coverage of a network.

In some other embodiments of the present application, the UE may obtain the slot structure information based on pre-configuration. Specifically, obtaining the slot structure information based on pre-configuration (i.e., the slot structure information is pre-configured to the UE) may refer to that: the slot structure information may be hard-wired into the UE or stored on a SIM or USIM card for the UE, such that the UE may obtain the slot structure information within the UE. In an embodiment of the present application, obtaining the slot structure information based on pre-configuration may apply to the scenario where the UE is out of coverage of the network.

In some embodiments of the present application, the slot structure information is based on at least one of the following granularities: per channel bandwidth, per carrier, per bandwidth part, per frequency range, or per SCS.

The slot structure information for an unlicensed spectrum may be the same as the slot structure information described above with respect to FIGS. 4-8. Accordingly, all the definitions regarding the slot structure information as described above with respect to FIGS. 4-8 may apply here.

For example, the slot structure information may include at least one of: a first set of starting symbols (also referred to as first symbols) for SL transmission; a second set of starting symbols (also referred to as first symbols) and a duration for S-SSB occasion(s); or time domain information indicating whether a slot includes S-SSB occasion(s) or not.

As described above, the distribution of S-SSB occasions and SL transmission resources in the time domain can be divided into case 1, case 2, and case 3 by considering whether an S-SSB occasion can be located within a slot for SL transmission or not. All the definitions regarding case 1, case 2, and case 3 as described above may apply here.

In some embodiments of case 1, the slot structure information may further indicate a maximum duration of S-SSBs (e.g., denoted by MaxS-SSBInCOTForSL) allowed within a COT for SL transmission. In some examples, the maximum duration may be in units of slots, symbols, ms, etc. In some examples, the maximum duration may be in units of S-SSB occasions. In some cases, the maximum duration may be greater than 0. In some other cases, the maximum duration may be equal to 0.

In some other embodiments of case 1, a regulation that there should be no S-SSB occasions included in a COT for SL transmission may be configured or pre-configured for the UE. For example, the slot structure information obtained in step 901 may indicate that a COT for SL transmission does not include any S-SSB occasion.

In some embodiments of case 2, the S-SSB and PSFCH may be configured periodically within a resource pool for SL transmission. In such embodiments, the slot structure information may also indicate slot(s) including S-SSB occasion(s), wherein the S-SSB occasion(s) is not allowed to be overlapping with location(s) of PSFCH in the slot(s).

In some other embodiments of case 2, the S-SSB may be configured periodically within a resource pool for SL transmission while PSFCH may be not configured periodically within a resource pool for SL transmission. In such embodiments, the UE may receive an indication indicating location(s) for PSFCH which does not overlap with S-SSB occasion(s).

In some other embodiments of case 2, the UE may further obtain, based on configuration or pre-configuration, an indication indicating whether a location is used for S-SSB or PSFCH when a collision between S-SSB and PSFCH occurs at the location. For example, the indication may be included in the slot structure information obtained in step 901.

In an embodiment, the indication may be based on a priority of S-SSB or PSFCH. For example, in the case that S-SSB is prioritized over PSFCH, the indication may indicate that the location is used for S-SSB when a collision between S-SSB and PSFCH occurs at the location. In the case that PSFCH is prioritized over S-SSB, the indication may indicate that the location is used for PSFCH when a collision between S-SSB and PSFCH occurs at the location.

In another embodiment, the indication may be defined as a default value, and the default value may indicate whether a location is used for S-SSB or PSFCH when a collision between S-SSB and PSFCH occurs at the location. For example, the default value may be “0,” which indicates that a location is used for S-SSB when a collision between S-SSB and PSFCH occurs at the location, or the default value may be “1,” which indicates that a location is used for PSFCH when a collision between S-SSB and PSFCH occurs at the location.

In the above embodiments, a location of PSFCH may refer to a symbol for PSFCH or a slot for PSFCH.

In some embodiments of case 3, the slot structure information may further include at least one of:
an indicator (e.g., S-SSBOccupiedByNon-S-SSB or S-SSBOccupiedBySL) indicating whether it is enabled or disabled to occupy an S-SSB occasion by a non-S-SSB transmission (e.g., dummy data, SL transmission, etc.); or
a parameter indicating a duration to identity whether an S-SSB occasion is used or not: in some embodiments, the identification regarding whether an S-SSB occasion is used or not may be done by such as sensing, LBT, or other methods; in some embodiments, the duration may be expressed in units of symbols.

Based on the above information, the UE may determine a third set of starting symbols for SL transmission, which is used for the UE to receive SL transmissions.

Specifically, in the case that the indicator indicates that it is enabled to occupy an S-SSB occasion by a non-S-SSB transmission, the UE may determine the third set of starting symbols for SL transmission within a slot based on the first set of starting symbols for SL transmission and the second set of starting symbols for S-SSB occasion(s). In the case that the indicator indicates that it is disabled to occupy an S-SSB occasion by a non-S-SSB transmission, the UE may determine (or set) the third set of starting symbols for SL transmission within a slot as same as the first set of starting symbols for SL transmission.

In step 903, the UE may receive SL transmission(s) based on the slot structure information obtained in step 901. For example, based on the slot structure information, the UE may determine at least one of the starting symbols for SL transmission(s) or starting symbols of S-SSB occasion within a slot, and then may receive SL transmission(s) based on the starting symbols of SL transmission(s). In some embodiments of the present application, the UE may receive SL transmission(s) based on the third set of starting symbols for SL transmission.

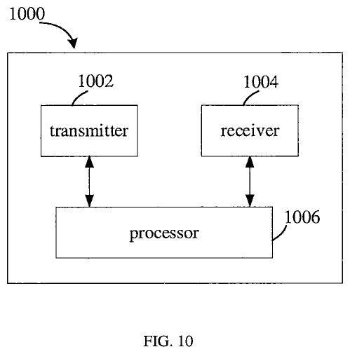

FIG. 10 illustrates a simplified block diagram of an exemplary apparatus 1000 for SL transmission and S-SSB transmission in an unlicensed spectrum according to some embodiments of the present application. In some embodiments, the apparatus 1000 may be or include at least part of a UE initiating a COT-based SL transmission or a UE receiving SL transmission(s) (e.g., UE 101a or UE 101b in FIG. 1). In some other embodiments, the apparatus 1000 may be or include at least part of a BS (e.g., BS 102 in FIG. 1).

Referring to FIG. 10, the apparatus 1000 may include at least one transmitter 1002, at least one receiver 1004, and at least one processor 1006. The at least one transmitter 1002 is coupled to the at least one processor 1006, and the at least one receiver 1004 is coupled to the at least one processor 1006.

Although in this figure, elements such as the transmitter 1002, the receiver 1004, and the processor 1006 are illustrated in the singular, the plural is contemplated unless a limitation to the singular is explicitly stated. In some embodiments of the present application, the transmitter 1002 and the receiver 1004 may be combined to one device, such as a transceiver. In some embodiments of the present application, the apparatus 1000 may further include an input device, a memory, and/or other components. The transmitter 1002, the receiver 1004, and the processor 1006 may be configured to perform any of the methods described herein (e.g., the method described with respect to any of FIGS. 4-9).

According to some embodiments of the present application, the apparatus 1000 may be a UE initiating a COT-based SL transmission, and the transmitter 1002, the receiver 1004, and the processor 1006 may be configured to perform operations of the method performed by a UE as described with respect to any of FIGS. 4-8. For example, the processor 1006 may be configured to: obtain slot structure information for an unlicensed spectrum based on configuration or pre-configuration, wherein the slot structure information includes at least one of the following: a first set of starting symbols for SL transmission; a second set of starting symbols and a duration for S-SSB occasion(s); or time domain information indicating whether a slot includes S-SSB occasion(s) or not; and perform a channel access procedure to initiate a COT for SL transmission based on the slot structure information, wherein the COT includes a plurality of consecutive slots.

According to some embodiments of the present application, the apparatus 1000 may be a UE receiving SL transmission(s), and the transmitter 1002, the receiver 1004, and the processor 1006 may be configured to perform operations of the method performed by a UE as described with respect to FIG. 9. For example, the processor 1006 may be configured to: obtain slot structure information for an unlicensed spectrum based on configuration or pre-configuration, wherein the slot structure information includes at least one of the following: a first set of starting symbols for SL transmission; a second set of starting symbols and a duration for S-SSB occasion(s); or time domain information indicating whether a slot includes S-SSB occasion(s) or not. The receiver 1004 may be configured to receive SL transmission(s) based on the slot structure information.

According to some embodiments of the present application, the apparatus 1000 may be a BS, and the transmitter 1002, the receiver 1004, and the processor 1006 may be configured to perform operations of the method performed by a BS as described with respect to any of FIGS. 4-9. For example, the transmitter 1002 may be configured to transmit slot structure information for an unlicensed spectrum, wherein the slot structure information includes at least one of the following: a first set of starting symbols for SL transmission; a second set of starting symbols and a duration for S-SSB occasion(s); or time domain information indicating whether a slot includes S-SSB occasion(s) or not.

In some embodiments of the present application, the apparatus 1000 may further include at least one non-transitory computer-readable medium. In some embodiments of the present disclosure, the non-transitory computer-readable medium may have stored thereon computer-executable instructions to cause the processor 1006 to implement any of the methods as described above. For example, the computer-executable instructions, when executed, may cause the processor 1006 to interact with the transmitter 1002 and/or the receiver 1004, so as to perform operations of the method, e.g., as described with respect to any of FIGS. 4-9.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for SL transmission and S-SSB transmission in an unlicensed spectrum, including a processor and a memory. Computer programmable instructions for implementing a method for SL transmission and S-SSB transmission in an unlicensed spectrum are stored in the memory, and the processor is configured to perform the computer programmable instructions to implement the method for SL transmission and S-SSB transmission in an unlicensed spectrum. The method for SL transmission and S-SSB transmission in an unlicensed spectrum may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for SL transmission and S-SSB transmission in an unlicensed spectrum according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE), comprising:
at least one memory; and
at least one processor coupled with the at least one memory and configured to cause the UE to:
obtain slot structure information for an unlicensed spectrum based on configuration or pre-configuration, wherein the slot structure information includes at least one of the following:
a first set of starting symbols for sidelink (SL) transmission;
a second set of starting symbols and a duration for sidelink synchronization signal block (S-SSB) occasion(s); or
time domain information indicating whether a slot includes S-SSB occasion(s) or not; and
perform a channel access procedure to initiate a channel occupancy time (COT) for SL transmission based on the slot structure information, wherein the COT includes a plurality of consecutive slots.

2. The UE of claim 1, wherein the slot structure information is based on at least one of the following granularities:
per channel bandwidth,
per carrier,
per bandwidth part,
per frequency range, or
per subcarrier spacing (SCS).

3. The UE of claim 1, wherein the at least one processor is configured to cause the UE to receive the slot structure information via at least one of: a master information block (MIB) message, a system information block (SIB) message, a radio resource control (RRC) signaling, a medium access control (MAC) control element (CE), or downlink control information (DCI).

4. The UE of claim 1, wherein at least one slot in the COT includes S-SSB occasion(s).

5. The UE of claim 4, wherein the slot structure information indicates a maximum duration of S-SSBs allowed within a COT for SL transmission.

6. The UE of claim 1, wherein at least one slot in the COT includes both an S-SSB occasion and time domain resource(s) for SL transmission, and the time domain resource(s) for SL transmission is located prior to the S-SSB occasion.

7. The UE of claim 6, wherein:
if S-SSB and physical sidelink feedback channel (PSFCH) are configured periodically within a resource pool for SL transmission, the slot structure information further indicates slot(s) including S-SSB occasion(s), wherein the S-SSB occasion(s) is not allowed to be overlapping with location(s) of PSFCH in the slot(s);
if S-SSB is configured periodically within a resource pool for SL transmission while PSFCH is not configured periodically within a resource pool for SL transmission, the at least one processor is configured to cause the UE to transmit an indication indicating location(s) of PSFCH which does not overlap with S-SSB occasion(s); or
the slot structure information further includes an indication indicating whether a location is used for S-SSB or PSFCH when a collision between S-SSB and PSFCH occurs at the location.

8. The UE of claim 7, wherein the indication indicating whether a location is used for S-SSB or PSFCH is based on a priority of S-SSB or PSFCH or is defined as a default value.

9. The UE of claim 1, wherein at least one slot in the COT includes both an S-SSB occasion and time domain resource(s) for SL transmission, and the S-SSB occasion is located prior to the time domain resource(s) for SL transmission.

10. The UE of claim 9, wherein the slot structure information further includes at least one of:
an indicator indicating whether it is enabled or disabled to occupy an S-SSB occasion by a non-S-SSB transmission; or
a parameter indicating a duration to identity whether an S-SSB occasion is used or not.

11. The UE of claim 10, wherein the at least one processor is configured to cause the UE to:
if the indicator indicates that it is enabled to occupy an S-SSB occasion by a non-S-SSB transmission, determine a third set of starting symbols for SL transmission within a slot based on the first set of starting symbols and the second set of starting symbols; or
if the indicator indicates that it is disabled to occupy an S-SSB occasion by a non-S-SSB transmission, determine the third set of starting symbols for SL transmission within a slot to be the first set of starting symbols.

12. The UE of claim 10, wherein, if the indicator indicates that it is enabled to occupy an S-SSB occasion by a non-S-SSB transmission and the UE does not intend to transmit an S-SSB on an S-SSB occasion within a slot of the at least one slot, the at least one processor is configured to cause the UE to:
perform a sensing operation from a beginning of the S-SSB occasion within the duration indicated by the parameter;
in response to determining that the S-SSB occasion is not used, perform at least one of the following operations:
performing a non-S-SSB transmission until an end of the S-SSB occasion; or
performing an SL transmission until the end of the slot including the S-SSB occasion.

13. The UE of claim 1, wherein, if at least one slot in the plurality of consecutive slots includes S-SSB occasion(s), the at least one processor is configured to cause the UE to perform at least one of the following steps:
transmitting an SL transmission in a first slot within the COT in response to determining that a channel is available for access prior to the first slot based on the channel access procedure;
transmitting an SL transmission in a slot within the COT other than the first slot in response to determining that a channel is available for access prior to the SL transmission based on a listen before talk (LBT) type 2 procedure associated with the SL transmission; or
transmitting an S-SSB transmission on an S-SSB occasion in a slot within the COT or skip the S-SSB occasion in the slot.

14. A user equipment (UE), comprising:
at least one memory; and
at least one processor coupled with the at least one memory and configured to cause the UE to:
obtain slot structure information for an unlicensed spectrum based on configuration or pre-configuration, wherein the slot structure information includes at least one of the following:
a first set of starting symbols for sidelink (SL) transmission;
a second set of starting symbols and a duration for sidelink synchronization signal block (S-SSB) occasion(s); or
time domain information indicating whether a slot includes S-SSB occasion(s) or not; and
receive SL transmission(s) based on the slot structure information.

15. A base station (BS), comprising:
at least one memory; and
at least one processor coupled with the at least one memory and configured to cause the base station to:
transmit slot structure information for an unlicensed spectrum, wherein the slot structure information includes at least one of the following:
a first set of starting symbols for sidelink (SL) transmission;
a second set of starting symbols and a duration for sidelink synchronization signal block (S-SSB) occasion(s); or
time domain information indicating whether a slot includes S-SSB occasion(s) or not.

16. The base station of claim 15, wherein the slot structure information is based on at least one of the following granularities:
per channel bandwidth,
per carrier,
per bandwidth part,
per frequency range, or
per subcarrier spacing (SCS).

17. A processor for wireless communication, comprising:
at least one controller coupled with at least one memory and configured to cause the processor to:
obtain slot structure information for an unlicensed spectrum based on configuration or pre-configuration, wherein the slot structure information includes at least one of the following:
a first set of starting symbols for sidelink (SL) transmission;
a second set of starting symbols and a duration for sidelink synchronization signal block (S-SSB) occasion(s); or
time domain information indicating whether a slot includes S-SSB occasion(s) or not; and
perform a channel access procedure to initiate a channel occupancy time (COT) for SL transmission based on the slot structure information, wherein the COT includes a plurality of consecutive slots.

18. The processor of claim 17, wherein the slot structure information is based on at least one of the following granularities:
per channel bandwidth,
per carrier,
per bandwidth part,
per frequency range, or
per subcarrier spacing (SCS).

19. The processor of claim 17, wherein the at least one controller is configured to cause the processor to receive the slot structure information via at least one of: a master information block (MIB) message, a system information block (SIB) message, a radio resource control (RRC) signaling, a medium access control (MAC) control element (CE), or downlink control information (DCI).

20. The processor of claim 17, wherein, if at least one slot in the plurality of consecutive slots includes S-SSB occasion(s), the at least one controller is configured to cause the processor to perform at least one of the following:
transmitting an SL transmission in a first slot within the COT in response to determining that a channel is available for access prior to the first slot based on the channel access procedure;
transmitting an SL transmission in a slot within the COT other than the first slot in response to determining that a channel is available for access prior to the SL transmission based on a listen before talk (LBT) type 2 procedure associated with the SL transmission; or
transmitting an S-SSB transmission on an S-SSB occasion in a slot within the COT or skip the S-SSB occasion in the slot.
